(19) United States
(12) Patent Application Publication
(10) Pub. No.: US 2010/0316969 A1
(43) Pub. Date: Dec. 16, 2010

(54) Method of Heating a Mineral Feedstock in a Firing Furnace of the Tunnel Furnace Type

(75) Inventors: Mohand Amirat, Gas (FR); Robert Kalcevic, Versailles (FR); Faustine Panier, Jouy en Josas (FR); Remi Tsiava, Saint Germain-Les-Corbeil (FR)

Correspondence Address: American Air Liquide, Inc.;Intellectual Property Dept., 2700 Post Oak Boulevard, Suite 1800, Houston, TX, 77056, US

(73) Assignee: L'Air Liquide Societe Anonyme Pour L'Etude Et L'Exploitation Des Procedes Georges Claude, Paris (FR)

(21) Appl. No.: 12/867,135

(22) PCT Filed: Feb. 11, 2009
(86) PCT No.: PCT/FR09/50219

§ 371 Date: Aug. 11, 2010

(30) Foreign Application Priority Data
Feb. 11, 2008 (FR) 0850831

(51) Int. Cl. F27D 3/00

(52) U.S. Cl. 432/11

(57) ABSTRACT

Method of heating a mineral feedstock in a firing furnace of the tunnel furnace type, having a hearth with an upstream inlet, a downstream outlet and sidewalls fitted with burners, in which method the feedstock is transported as a layer of approximately constant thickness along a treatment path in which the feedstock is heated and fired by means of said burners so as to obtain a fired product, said path being located between the upstream inlet and the downstream outlet of the furnace, characterized in that said burners comprise at least one fuel injector and at least one oxidizer injector and are positioned and oriented in such a way that their flames do not impact the layer, the at least one oxidizer injector being positioned relative to the at least one fuel injector so that the at least one fuel jet injected by the at least one fuel injector is separated from the layer by at least one oxidizer jet injected by at least one oxidizer injector.

The present invention relates to a method for heating a mineral feedstock in a tunnel-type firing furnace or kiln.

CO₂ emissions due to human activity are probably responsible for a large part of the observed global warming-induced climate change. This observation resulted especially in the signing of the Kyoto protocol. Since then, an increasing number of countries are setting objectives in terms of limiting CO₂ emissions. In the case of the European Union for example, the implementation of this protocol has resulted in a system of allocating CO₂ emission quotas.

With emissions of about 0.7 to 0.8 metric tons of CO₂ per metric ton of cement produced, cement works are among the largest emitters in the world (close to 5% of the global emissions due to human activity). Cement works must therefore be particularly active in searching for means to reduce their CO₂ emissions.

The means employed and the lines of research for reducing CO₂ emissions vary. Among these lines of research may be the use of biofuels, CO₂ capture, with a view to its sequestration, or even ways of modifying the composition of the feedstock, with more addition.

The question of reducing CO₂ emissions also arises in the firing of other mineral feedstocks.

In cement manufacture, the raw material, called the feedstock, which is mainly a mixture of clay and limestone, is: firstly (1) homogenized, typically by milling, and (2) dried, then (3) heated, typically up to about 900° C., and (4) decarbonized—at the heating temperature, calcium carbonate decomposes to give lime and carbon dioxide—and then (5) clinkerized. The clinker thus obtained is air-quenched and then milled with gypsum to form the cement.

The clinker is obtained by high-temperature firing (clinkerization), generally at between 1100° C. and 1400° C., of the decarbonized feedstock. At this temperature, the lime and the various components of the material recombine to form the clinker. Usually, the clinkerization takes place in a rotary kiln.

It has also been proposed to use a tunnel kiln to fire the clinker. Thus, it is known from WO-A-02/094732 to manufacture sulfo-aluminous and/or ferro-aluminous cement by the clinkerization of a particular feedstock in a tunnel kiln, said feedstock being treated until clinkerization by moving through the hearth of the kiln as a layer of approximately constant thickness and with an approximately constant speed of movement, along a treatment path subjected to a positive temperature gradient and for a treatment time during which the feedstock remains below its melting point, the clinkerized product being cooled on leaving the treatment path.

The firing of a mineral feedstock, and in particular the clinkerization, in a tunnel kiln must be carried out under stable operating conditions so as to preserve the plant, to reduce expensive maintenance and to ensure quality of the fired product.

Apart from exceptional cases, the clinkerization advantageously takes place in an oxidizing medium. Otherwise, the sulfur contained in the feedstock (as SO₄²⁻) is reduced to SO₂ and leaves with the combustion gases. This poses two problems: firstly the flue gases must then be decontaminated and secondly the loss of the SO₄²⁻ element in the clinker is detrimental to clinker quality. Similar considerations arise when firing other mineral feedstocks.

However, too high a surplus of oxygen degrades the energy performance of the plant. This is because an oxygen surplus dilutes and lowers the temperatures and overconsumption of oxygen wastes the oxygen, which is expensive.

The object of the present invention is to provide a combustion technology suitable for tunnel kilns that meets the constraints described above.

The present invention relates in particular to a method of heating a mineral feedstock in a tunnel-type firing kiln having a hearth with an upstream inlet, a downstream outlet and sidewalls fitted with burners. The feedstock follows a treatment path located between the upstream inlet and the downstream outlet of the hearth. The feedstock is transported as a layer of approximately constant thickness along the treatment path in which the feedstock is heated and fired by means of said burners so as to obtain a fired product, such as clinker. Said burners comprise at least one fuel injector and at least one oxidant injector, said oxidant having an oxygen content greater than 22 vol %. These burners are called hereafter “oxy-fuel” burners. These oxy-fuel burners are positioned and oriented so that their flames do not impact the layer. According to the invention, the at least one oxidant injector is positioned relative to the at least one fuel injector so that the at least one fuel jet injected by the at least one fuel injector is separated from the layer by at least one oxidant jet injected by at least one oxidant injector. Thus, at least one oxidant jet is inserted between each fuel jet and the layer. However, as will be explained in greater detail below, it is unnecessary for all of one oxidant jet or for all the oxidant jets to be inserted between a fuel jet and the layer.

Thanks to this way of positioning the fuel and oxidant injectors, an oxidizing atmosphere is created directly above the feedstock layer.

As indicated above, in tunnel kilns the feedstock is transported between the upstream inlet and the downstream outlet of the hearth. To transport the feedstock, tunnel kilns are fitted with appropriate mechanical transport means suitable for the temperatures within the hearth. Thus, the feedstock may be transported through the hearth by means of rollers, as particularly described in WO-A-02/094732, on one or more conveyor belts or on the kiln cars, as described in part 2.2.7.4.2 “Tunnel kilns” of the European Commission reference document entitled “Reference Document on Best Available Techniques in the Ceramic Manufacturing Industry”, August 2007.

Tunnel kilns are thus distinguished from rotary kilns, which are not fitted with such means for transporting the feedstock and in which particularly the feedstock is typically transported under the effect of gravity by the rotary kiln itself being tilted.

The fired product is typically cooled on leaving the treatment path.

According to one embodiment, at least one oxy-fuel burner is a concentric-injection oxy-fuel burner with peripheral oxidant injection enabling an oxidizing atmosphere to be created around the outside of the flame envelope. In this case, the oxidant jet injected by the peripheral injection surrounds the fuel jet, the lower portion of the peripheral oxidant jet being inserted between the fuel jet and the layer, thus separating the fuel jet from the layer. Preferably, the method makes use of several such concentric-injection oxy-fuel burners. Advantageously, all the oxy-fuel burners mounted in the sidewalls of the hearth are such concentric-injection oxy-fuel burners.

While the mineral feedstock is being heated in a tunnel firing kiln, the feedstock is static on a moving car or a moving belt. To obtain uniform heating of the charge, there must be substantially uniform heat transfer over the width of the kiln. Such substantially uniform heat transfer may be achieved by means of an embodiment in which at least one oxy-fuel burner is a concentric-injection oxy-fuel burner with:
peripheral oxygen injection;
central oxygen injection; and
fuel injection between the peripheral oxygen injection and the central oxygen injection.

Preferably, a plurality, or even all, of the oxy-fuel burners are oxy-fuel burners of this type.

The oxidant jet injected by the central oxidant injection is advantageously injected with a higher momentum than the oxidant jet injected by the peripheral oxidant injection.

In this type of burner with central and peripheral oxidant injection, it is possible, in the method according to the invention, to adjust the length of the flame emanating from the burner of this type by regulating the distribution between the oxidant jet injected by the central oxidant injection and the oxidant jet injected by the peripheral oxidant injection. The oxidant jet injected by the central oxidant injection represents between 8% and 30% of the total amount of oxygen injected by the oxy-fuel burner. Another advantage that burners of this type have is their good power adaptability.

According to one embodiment, at least one of the oxy-fuel burners comprises one or more lower oxidant injectors located beneath the at least one fuel injector so that the oxidant jet or jets injected by the lower injector or injectors separate the at least one fuel jet injected by the at least one fuel injector from the layer. Thus, the oxidant jet or jets injected by the lower injector or injectors is or are inserted between the fuel jet or jets and the layer. It should be noted that it is unnecessary for all of the oxidant injectors to be lower injectors located beneath the fuel injector or injectors. This is because the oxy-fuel burner may also comprise one or more oxidant injectors located level with one or more fuel injectors and/or also located at a level above one or more fuel injectors.

When the oxy-fuel burner comprises one or more lower oxidant injectors as described above, the oxy-fuel burner is advantageously an oxy-fuel burner with staged oxidant injection. In the case of an oxy-fuel burner with staged oxidant injection, a first portion of the oxidant, called the primary oxidant, is injected close to the fuel jet or jets, a second portion of the oxidant, called the secondary oxidant, being injected at a larger distance from the fuel jet or jets and a third portion of the oxidant, called the tertiary oxidant, being optionally injected at an even greater distance from the fuel jet or jets. In this way, staged combustion is achieved: in a first combustion phase, the fuel jet or jets react with the primary oxidant, the remainder of the fuel after the primary combustion and the combustion products of this primary combustion then being brought into contact with the secondary oxidant in a secondary combustion and, in the particular case in which the oxidant is distributed as primary, secondary and tertiary oxidant, the fuel remaining after the secondary combustion and the combustion products resulting from this secondary combustion come into contact with the tertiary oxidant in a tertiary combustion phase.

Each fuel injector is connected to a fuel supply.

Each oxidant injector is connected to an oxidant supply.

The fuels used are preferably low-cost fuels (coal, petroleum coke, waste, etc.) conventionally used by cement works. However, it is advantageously conceivable to use gaseous fuels (natural gas, propane, etc.) or liquid fuels (fuel oil).

As mentioned above, the oxygen content of the oxidant is greater than 22 vol %. The oxygen content of the oxidant is advantageously greater than 50 vol %, preferably greater than 70 vol % and even more preferably greater than 80 vol %.

The invention also relates to the use of the heating method described above in the manufacture of lime or clinker.

A tunnel kiln for heating a mineral feedstock with production of a fired product suitable for implementing the method comprises a hearth having an upstream inlet, a downstream outlet and sidewalls fitted with burners. Such a kiln also includes means for introducing a layer of mineral feedstock into the hearth via the upstream inlet, means for discharging the layer of fired product from the hearth via the downstream outlet, and means for transporting the layer along a treatment path between the upstream inlet and the downstream outlet, such as cars, rollers or conveyor belts. The burners with which the sidewalls of the hearth are fitted are burners according to any one of the embodiments described above. These burners are therefore oxy-fuel burners comprising at least one fuel injector and at least one oxidant injector. They are positioned and oriented so that their flames do not impact the layer. The at least one oxidant injector of these burners is positioned relative to the at least one fuel injector so that the at least one fuel jet injected by the at least one fuel injector is separated from the layer by at least one oxidant jet injected by at least one oxidant injector.

The proposed technology is applicable to the manufacture of various types of clinker, such as clinker for sulfo-aluminous and/or ferro-aluminous cement cited in WO-A-02/094732, clinker for Portland cement, the manufacture of lime or the firing of other mineral products. The technology is particularly useful for the firing of a mineral feedstock having a composition such that to fire it requires good control of the heat transfer to the feedstock, such as a feedstock for sulfo-aluminous and/or ferro-aluminous cement.

The present invention makes it possible to create an atmosphere with a relatively uniform temperature above the layer with the desired longitudinal profile.

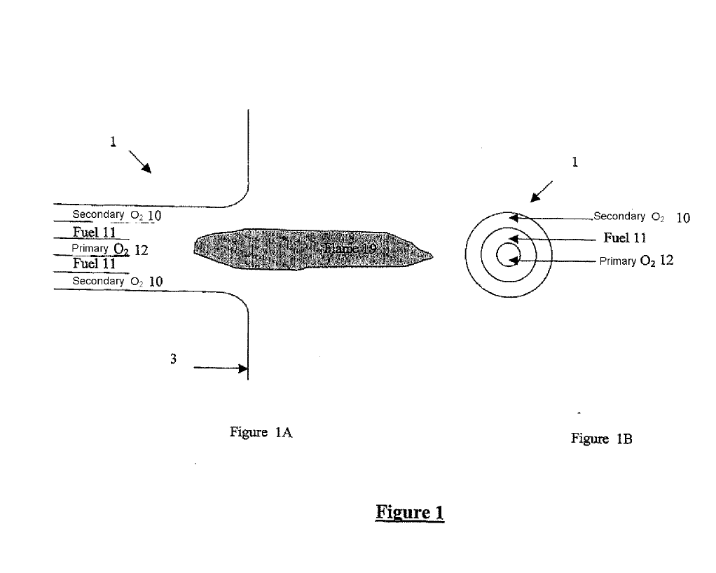

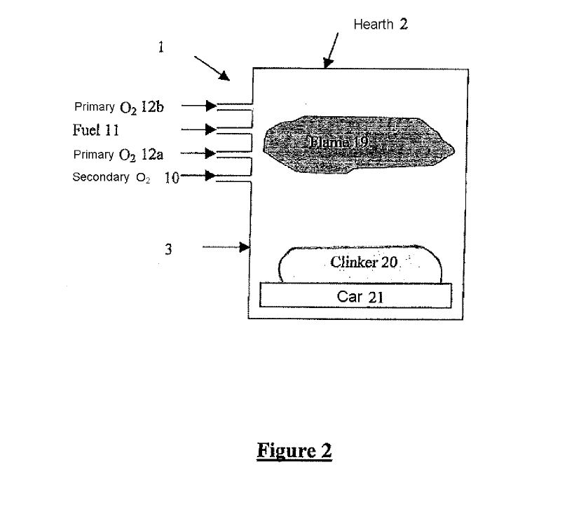

The advantages of the present invention will be better understood in the light of the examples of the invention described below, reference being made to FIGS. 1 and 2 in which:

FIG. 1 is a schematic representation of a concentric-injection burner suitable for the method according to the invention, FIG. 1A representing a cross section and FIG. 1B the front view; and

FIG. 2 is a schematic representation in cross section of the hearth of a tunnel kiln suitable for implementing the method according to the invention, fitted with a second type of burner.

The following examples relate more particularly to clinkerization.

The tunnel or hearth is fitted with aligned oxy-fuel burners on the side of the kiln, on either side of the material layer. Said burners are positioned in the sidewalls and oriented so that their flames do not impact the charge.

The fuel used is a fuel conventionally used by cement works, such as coal, petroleum coke, waste. It is also possible to use gaseous fuels (natural gas, propane, etc.) or liquid fuels (fuel oil).

As already mentioned above, the oxygen content in the oxidant of an oxy-fuel burner is greater than 22 vol %, preferably greater than 50 vol %, more preferably greater than 70 vol % and even more preferably greater than 80 vol %. Various burner types are proposed to create the suitable atmosphere for the material:

a. Oxy-Fuel Burners with Concentric Fuel/Oxidant Injection (FIG. 1)

The burner 1 in the sidewall 3 is a concentric-injection oxy-fuel burner with peripheral oxidant injection 10 surrounding the fuel injection 11 and enabling an oxidizing atmosphere to be created around the outside of the flame envelope 19. This oxidizing atmosphere prevents excessive reduction of the sulfates contained in the feedstock.

Moreover, the need to preserve the kiln or to adapt the heat transfer over the width thereof (for example following a change in the composition of the feedstock or in the kiln production throughput) may require the length of the flame 19 produced by one or more burners to be changed. To do this, it is possible to use concentric-injection burners with:
injection of the peripheral oxidant 10 surrounding the fuel injection 11, to create an oxidizing atmosphere around the outside of the flame envelope, as mentioned above; and
injection of the central oxidant 12 surrounded by the fuel injection 11, enabling the reactants to be better mixed and the length of the flame 19 to be adjusted.

The distribution between the peripheral oxidant flow rate and the central oxidant flow rate is adjusted according to the desired power and the desired flame length.

Typically, the central or primary oxidant 12, injected with a higher momentum than the secondary oxidant 10, enables the flame length to be adjusted. The proportion of this oxidant is typically such that the central oxidant 12 delivers between 8% and 30%, for example around 15%, of the total amount of oxygen injected by the burner. For constant stoichiometry, the increase in the proportion of primary oxygen (oxygen delivered by the central oxidant) reduces the length of the flame, improving the oxidant/fuel mixing.

b. Oxy-Fuel Burners with Spaced-Apart Fuel/Oxidant Injection (FIG. 2)

According to the second example, the fuel injection into the hearth 2 is separated, that is to say spaced apart, from the oxidant injection into the clinkerization kiln.

A first line of oxidant (secondary oxidant) injectors 10 is at a level directly above the level of the layer 20 transported on the car 21 and beneath the fuel injector or injectors 11, at least one primary oxidant injector 12 being located at a shorter distance (relative to this first line of injectors 10) from the fuel injector or injectors 11 and at a larger distance (relative to this first line of injectors 10) from the layer 20. Such a burner 1 in the sidewall 3 again enables an oxidizing atmosphere to be created above the layer 20 and around the outside of the flame envelope 19. This oxidizing atmosphere prevents excessive reduction of the sulfates contained in the feedstock.

Similarly to Example 1:
the first line of oxidant (secondary oxidant) injectors 10 enables an oxidizing atmosphere to be created above the layer 20 around the outside of the flame envelope 19; and
the other oxidant (primary oxidant) injectors 12 enable the reactants to be better mixed and the length of the flame 19 to be adjusted.

The distribution between the oxidant flow rates of the various oxidant injectors 10, 12 is adjusted according to the desired power and to the desired length of the flame 19.

In the example illustrated in FIG. 2, additional lines of oxidant (primary oxidant) injectors 12 are located (a) above this first line of injectors but beneath the fuel injector or injectors 11 (line 12a) and (b) above the fuel injector or injectors 11 (line 12b).

The spacing of the injection lines depends inter alia on the width of the kiln. The calculation of this spacing, and in particular the spacing between the fuel injector and the primary oxidant injectors, during the design stage provides optimization between flame length and NOx reduction.

The power of the various oxy-fuel burners along the hearth 2 of the clinkerization kiln is adjusted so as to obtain the desired heating profile.

The level of the oxidant injection lines and the spacing of the injections along a given line may also vary over the length of the clinkerization kiln so as to achieve suitable heat transfer.

Oxy-fuel burners suitable for the present invention, enabling inter alia the length of a flame to be varied during operation and to be adjusted at will, are described in the Applicant's patents and patent application. Thus:
EP-A-0 763 692, EP-A-1 016 825, EP-A-1 195 557 and FR-A-2 837 916 describe oxy-fuel burners sold under the brand name ALGLASS VM™ that allow the flame length to be modified by modifying the central or peripheral oxygen distribution (“variable-momentum” burners) as in Example 1 above; and
FR-A-2 823 290, EP-A-1 618 334, EP-A-1 702 177 and EP-A-1 704 366 describe separate-injection oxy-fuel burners with staging of the oxygen injection and oxidant distribution adjustment, sold under the brand name ALGLASS SUN™.

A common point in these technologies is the ability to modify the flame characteristics in operation.

1-10. (canceled)

11. A method of heating a mineral feedstock in a tunnel-type firing kiln having a hearth with an upstream inlet, a downstream outlet and sidewalls fitted with burners, and a treatment path located between the upstream inlet and the downstream outlet of the hearth, the method comprising the steps of
a) transporting the mineral feedstock along the treatment path as a layer having an approximately constant thickness
b) heating and firing the mineral feedstock by operating the burners so as to obtain a fired product,
wherein said burners are configured so that their flames do not impact the layer during burner operation, and
wherein the burner comprises at least one fuel injector and at least one oxidant injector wherein the at least one oxidant injector is positioned relative to the at least one fuel injector so that upon burner operation a fuel jet injected by the at least one fuel injector is separated from the layer by an oxidant jet injected by the at least one oxidant injector.

12. The method of claim 11, wherein at least one burner is a concentric-injection burner with peripheral oxidant injection capable of providing an oxidizing atmosphere around the outside of a flame envelope of the flame.

13. The method of claim 12, wherein at least one burner is a concentric-injection burner with peripheral oxidant injection, central oxidant injection and fuel injection between the peripheral oxidant injection and the central oxidant injection.

14. The method of claim 13, wherein the oxidant jet injected by the central oxidant injection is injected with a higher momentum than the oxidant jet injected by the peripheral oxidant injection.

15. The method of claim 13, wherein the length of the flame emanating from a concentric-injection burner, with peripheral oxygen injection, central oxygen injection and fuel injection between the peripheral oxygen injection and the central oxygen injection, is adjusted by regulating the distribution between the oxidant jet injected by the central oxidant injection and the oxidant jet injected by the peripheral oxidant injection.

16. The method of claim 13, wherein the oxidant jet injected by the central oxidant injection represents between 8% and 30% of the total amount of oxygen injected by the burner.

17. The method of claim 11, wherein at least one burner comprises one or more lower oxidant injectors located beneath the at least one fuel injector so that the oxidant jets injected by said one or more lower oxidant injectors separate fuel jet injected by the at least one fuel injector from the layer.

18. The method of claim 17, wherein at least one of the burners comprising one or more lower oxidant injectors located beneath the at least one fuel injector is a burner with staged oxidant injection.

19. The method of claim 11, wherein the oxidant has an oxygen content of at least 50 vol %.

20. The method of claim 11, wherein the oxidant has an oxygen content of at least 70 vol %.

21. The method of claim 11, wherein the oxidant has an oxygen content of at least 80 vol %.
